(19) United States
(12) Patent Application Publication
(10) Pub. No.: US 2012/0047454 A1
(43) Pub. Date: Feb. 23, 2012

(54) Dynamic Soft Input

(76) Inventor: Erik Anthony Harte, Seattle, WA (US)

(21) Appl. No.: 13/194,975

(22) Filed: Jul. 31, 2011

Related U.S. Application Data
(60) Provisional application No. 61/374,968, filed on Aug. 18, 2010.

(51) Int. Cl. G06F 3/048

(52) U.S. Cl. 715/773

(57) ABSTRACT

Devices and methods are disclosed which relate to improving the efficiency of text input by dynamically generating a soft input based upon current context information. In some embodiments the dynamic soft input may comprise a reduced set of input areas (e.g., keys), which may be sized and/or positioned according to their relative probability of being selected as the next user input. In addition, in some embodiments the probability that an input will be selected may be determined by comparing the current context (e.g., user inputs) to an input model, such as a language model.

### CROSS-REFERENCE TO RELATED APPLICATIONS

This application claims the benefit of provisional patent application Ser. No. 61/374,968, filed Aug. 18, 2010 by the present inventor.

### BACKGROUND

### Prior Art

The following is a tabulation of some prior art that presently appears relevant:

U.S. Patents

| Pat. No. | Kind Code | Issue Date | Patentee |
|---|---|---|---|
| 6,573,844 | B1 | Jun. 03, 2003 | Venolia |
| 5,128,672 | | Jul. 07, 1992 | Kaehler |
| 6,654,733 | B1 | Nov. 25, 2003 | Goodman |
| 6,359,572 | B1 | Mar. 19, 2002 | Vale |
| 7,251,367 | B2 | Jul. 31, 2007 | Zhai |
| 7,098,896 | B1 | Jul. 29, 2006 | Kushler |

U.S. Patent Application Publications

| Publication | Kind | Publication | |
|---|---|---|---|
| Number | Code | Date | Applicant |
| 2010/0110012 | A1 | May 06, 2010 | Maw |
| 2011/0078613 | A1 | Mar. 31, 2011 | Bangalore |

Nonpatent Literature Documents

Tree Visualization with Tree-Maps: A 2-d Space-Filling Approach.
B Schneiderman - ACM Transactions on Graphics, 1992
Squarified Treemaps. Mark Bruls, Kees Huizing, Jarke van Wijk -
Proceedings of the Joint Eurographics and IEEE TCVG Symposium
on Visualization, 1999

Virtual keyboards or soft-inputs are quite commonly used for text entry on mobile devices. These often use statistical methods to determine the next character or sequence likely to be selected by the user in order to increase text entry speed, as in U.S. Pat. No. 6,654,733 to Goodman et al. (2003).

These soft-inputs are commonly used in small, often handheld, mobile devices such as PDA's or smartphones. On these devices displaying a full traditional keyboard, such as the ‘QWERTY” layout for English language input, results in the keys being so small as to be often difficult for users to select quickly and accurately, causing mistakes and slowing down text entry. Several proposals have been made which combine the statistical prediction of the characters with an increase the size of some of the more likely characters—for example, in U.S. patent application 2010/0110012 to Maw (2007) and U.S. patent application 2011/0078613 to Bangalore (2009). These soft-inputs display the full keyboard but though they do increase the displayed size of the likely next characters, they do so at the expense of decreasing the already small size of the less likely ones. Further, keeping all of the characters oriented in their traditional locations limits how large the most likely ones may be displayed. Additionally, the traditional keyboard layouts, such as “QWERTY” are most useful for touch-typists, that is, experienced or trained people who type without looking at the keyboard, but the devices which implement these soft-inputs are often far too small to be operated normally with both hands and are typically operated with one or two fingers at most. Therefore the user must still search visually over the soft-input to find the character they want to select even if they are a normally experienced touch-typist, so much of the advantage that could gained by retaining the traditional layout is lost. Other soft-input entry methods have been proposed which also use a traditional layout but attempt to solve the typing in a different fashion. The gesturing methods—for example, U.S. Pat. Nos. 7,251,367 to Zhai (2007) and 7,098,896 to Kushler (2006). These methods, however, have the double disadvantages of requiring the user to both be familiar with the traditional keyboard layouts and also be a good speller, especially for longer words. Additionally, for smaller words there can be additional time and effort involved in disambiguating the intended gestural input which mitigates the time savings—distinguishing between “great” and “grease”, for example. For many users these gesturing methods can often prove to be slower and more frustrating then other types of soft-input.

### SUMMARY

In accordance with one embodiment, a method of enhancing a dynamic soft input comprises obtaining from an input model or language model a set of tuplets of probabilities and keys corresponding to a set of predicted likely keys and probabilities based on input from a user, determining a reduced set of keys from said series of tuplets, determining the sizes, shapes, and locations for each key in said reduced set, and displaying said reduced set of keys at said locations on the soft input with said shapes and sizes.

### Advantages

Accordingly advantages of one or more aspects are as follows: to provide a dynamic soft input which has a reduced set of keys that are displayed much larger than provided by traditional displays which may be selected with greater speed and accuracy, and are selected, sized and clustered together on the display device based on their probability of being next chosen by the user. Other advantages of one or more aspects will be apparent from a consideration of the drawings and ensuing description.

### DRAWINGS

### Figures

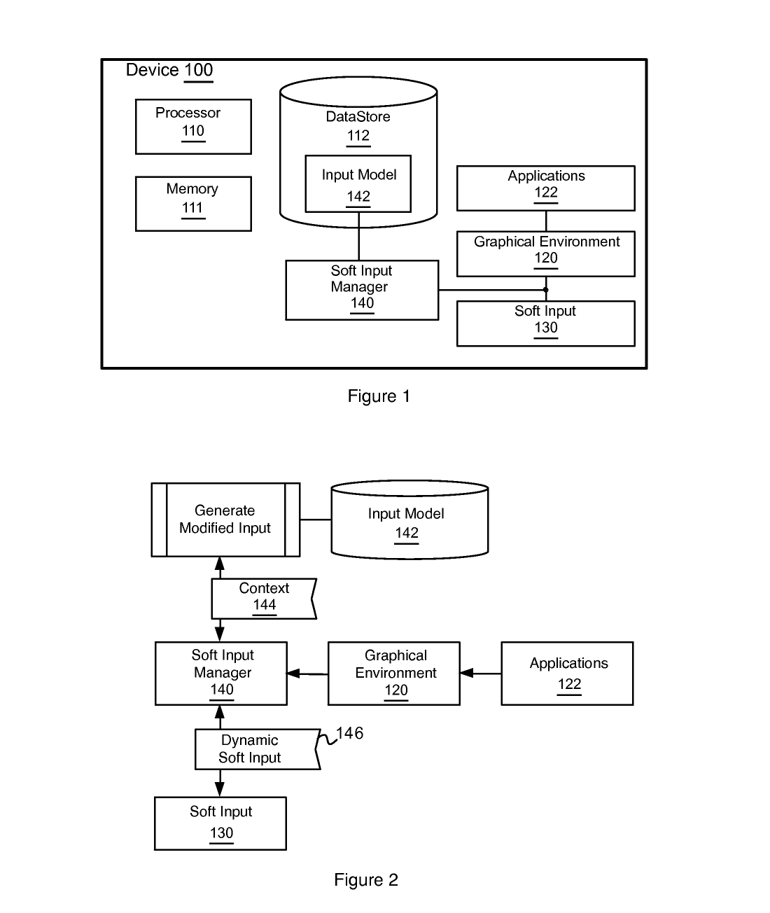

FIG. 1 is a block diagram of one embodiment of a computing device comprising a dynamic soft input.

FIG. 2 is a data flow diagram for generating a dynamic soft input.

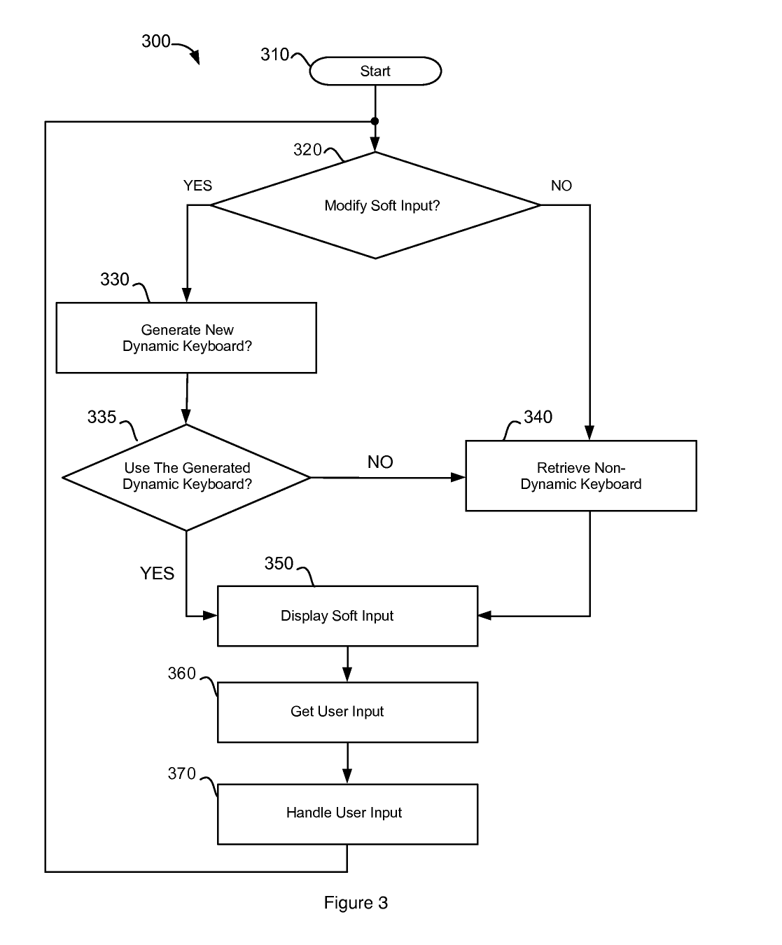

FIG. 3 is a flow diagram of one embodiment of a method for generating a dynamic soft input.

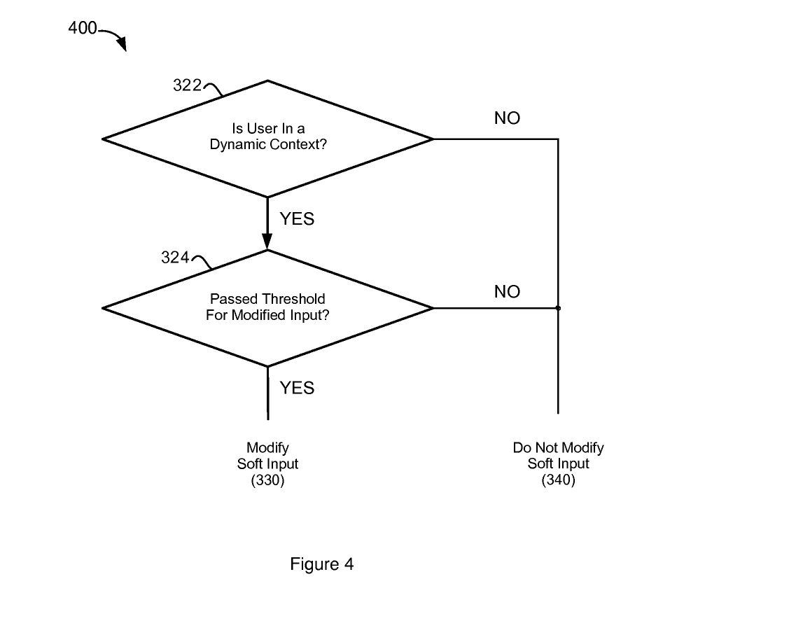

FIG. 4 is a flow diagram of one embodiment of a method from determining whether to generate a dynamic soft input.

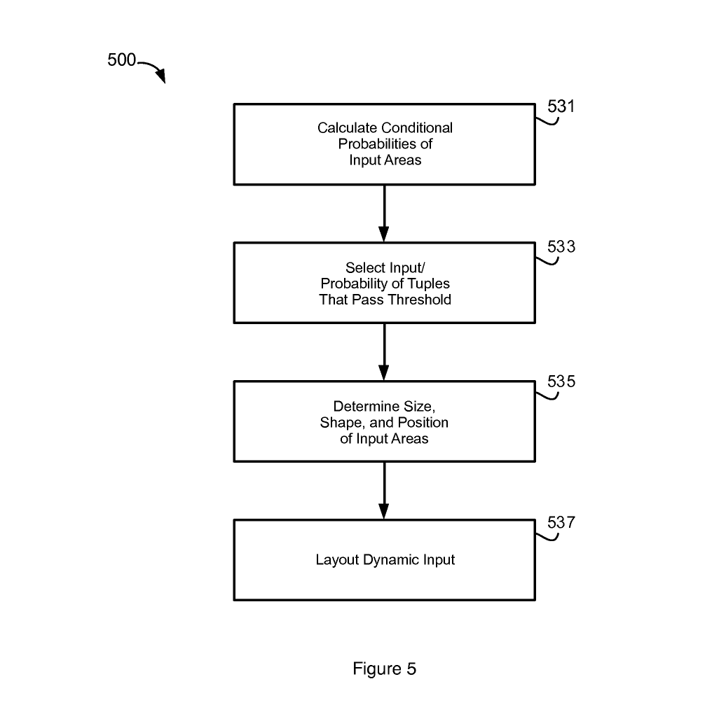

FIG. 5 is a flow diagram of one embodiment for generating a dynamic soft input.

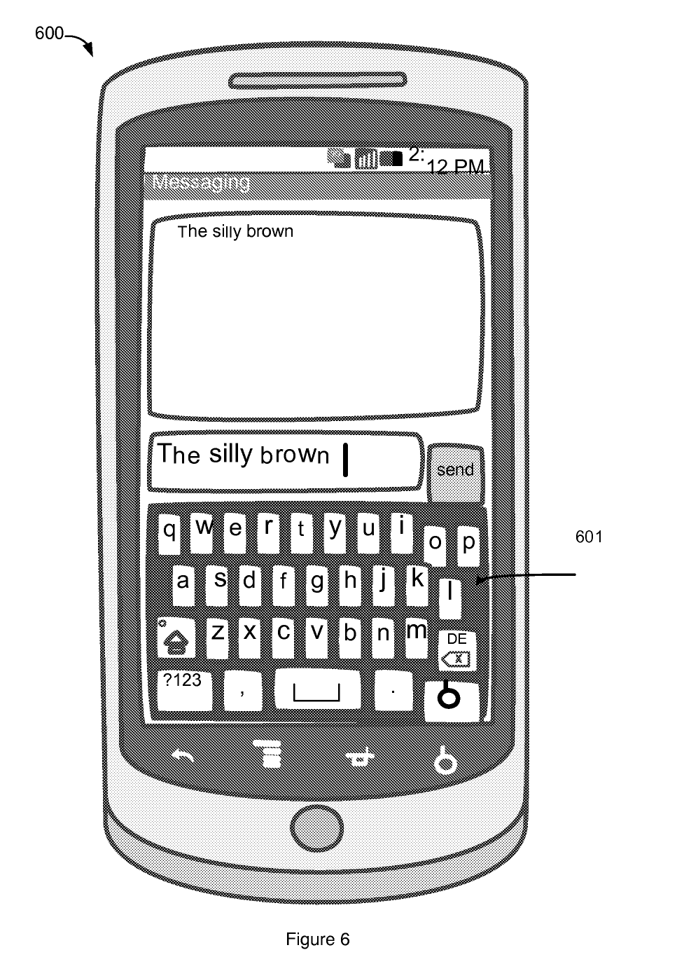

FIG. 6 shows one embodiment of mobile device comprising a dynamic soft input.

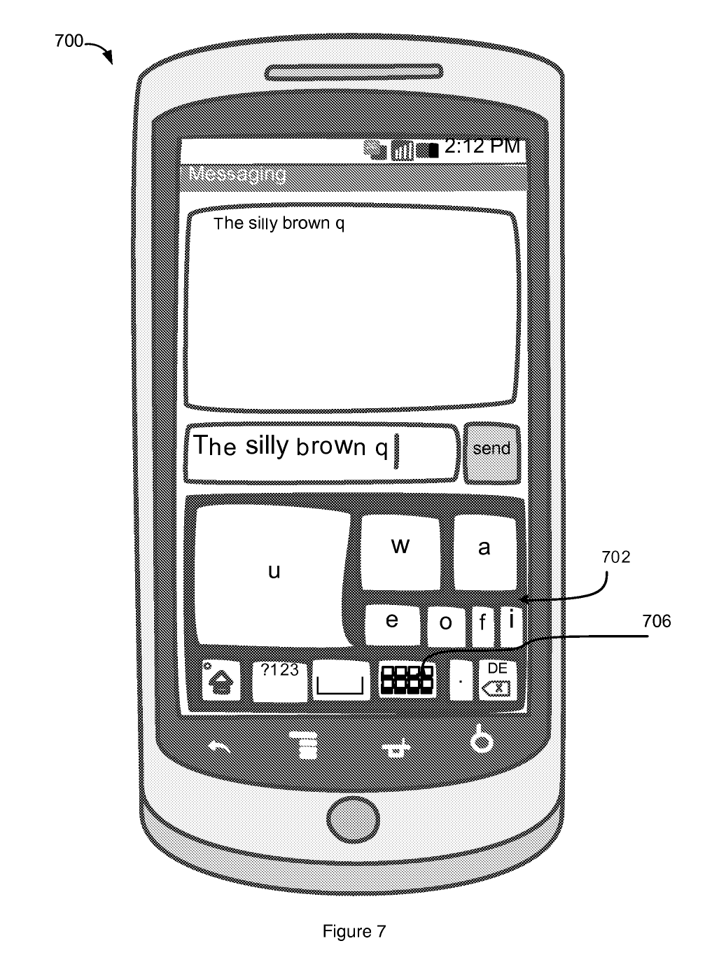

FIG. 7 shows the dynamic soft input after a “q” has been entered as the first character of a word.

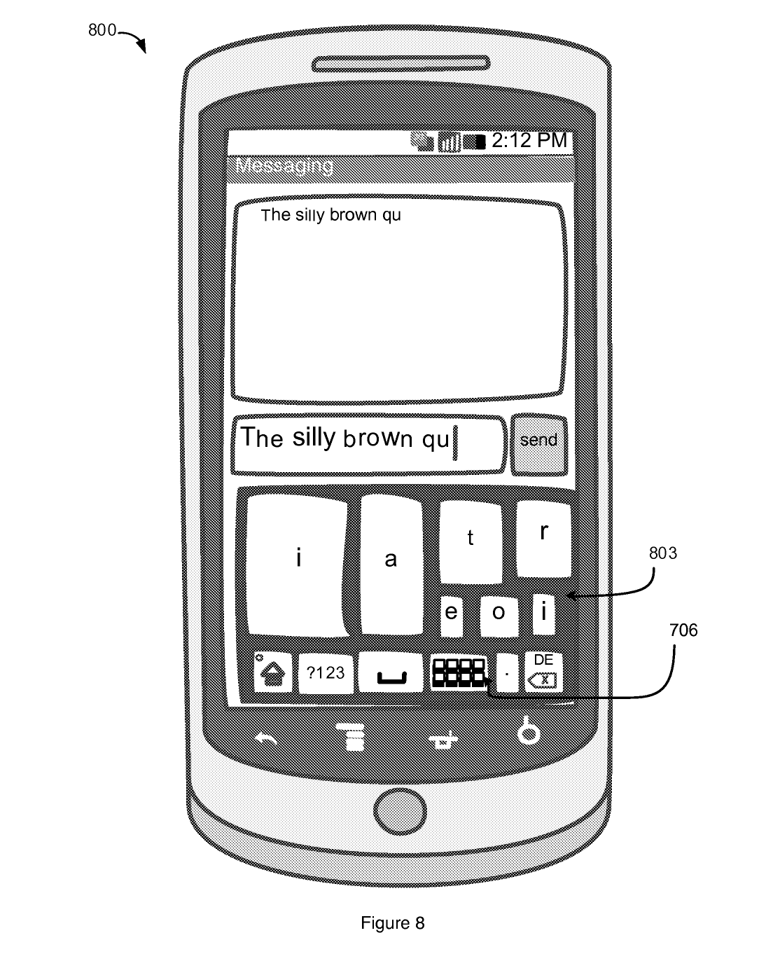

FIG. 8 shows the dynamic soft input after both a “q” and a “u” have been entered as the first two characters of a word.

### DETAILED DESCRIPTION

A device, such as a tablet or “pad,” e-book reader, or the like may comprise a human-machine interface (HMI) comprising one or more dynamic “soft” inputs (e.g., a soft keyboard). As used herein, a dynamic “soft” input may be any input that is capable of being reconfigured. A soft input may be implemented in various ways, including but are not limited to: a user interface presented on a display interface (e.g., a monitor, a touchscreen, or the like); an input created by projecting an interface onto a surface, or the like. In some embodiments, a soft input may be configured to receive text inputs; for example, a soft input may comprise a QWERTY keyboard (or other type of keyboard layout). Alternatively, a soft input may comprise a hierarchical menu (or series of menu choices) as used in a point-of-sale device, kiosk, or the like.

A wide variety of devices may comprise a soft input including, but not limited to: tablet computing devices (e.g., a pad or “slate” computer), e-book readers, notebook computers, laptop computers, communication devices (e.g., cellular phone, smart phone, IP phone), personal computing devices, point-of-sale devices, kiosks (e.g., photo processing kiosk), control interfaces (e.g., home automation, media player, etc.), or the like.

In some embodiments, a soft input may comprise an input layout, comprising a plurality of input areas (e.g., keys), each representing one or more text characters or other inputs. The one or more text characters may be selected using various input mechanisms including, but not limited to: actuating an input (e.g., pressing a key), touching a touch-sensitive surface, manipulating a pointer (e.g., mouse, touch pad, or the like), gesturing, and so on.

A soft input may operate within a limited area. Accordingly, the input areas comprising the soft input may be so small that they are difficult for some users to read and/or accurately select. Similarly, the sensitivity of the touch-sensitive surface upon which the soft input is implemented may be insufficient to distinguish closely spaced input areas.

In some embodiments, a soft input may be dynamically modified during operation to present a user with a reduced set of input areas. The input areas in dynamic soft input may be rearranged and/or resized. Since the dynamic soft input comprises a reduced set of input areas (as opposed to the “full” keyboard), some of the input areas may be substantially enlarged, making them easier for users to identify and/or select. The input areas that are included in the reduced set (and their relative size, order, and/or position within the dynamic soft input) may be selected according to contextual information. The dynamic soft input may be continually updated during user operation.

FIG. 1 depicts one embodiment of a device 100 comprising a dynamic soft input. The device 100 may be a computing device comprising a processor 110 and datastore 112. The datastore 112 may comprise a non-transitory computer-readable storage medium (e.g., a disc, solid-state memory, EEPROM, or the like).

The device 100 may include graphical environment 120, which may be operable on the processor 110 and may support one or more applications 122. In some embodiments, the graphical environment 120 may comprise an operating system (not shown), which may be configured to manage the resources of the device 100 (e.g., processor 110, memory 111, datastore 112, HMI components (not shown), and so on). The device 100 may include a soft input 130, which, as discussed above, may be implemented using HMI components (not shown), such as a display, a touch screen, a touch pad, a projector, pointing devices, or the like. The soft input 130 may display a plurality of input areas, each of which may correspond to an input selection (e.g., one or more text characters). In some embodiments, the soft input 130 may comprise a QWERTY keyboard.

A soft input manager 140 may be configured to dynamically modify the soft input 130. The soft input manager 140 may be operable on the processor 110 and/or implemented using machine-readable instructions stored on the datastore 112. The modifications to the soft input 130 may include, but are not limited to: selecting a reduced set of input areas to display in the soft input 130 (e.g., reduced set of input areas or keys), modifying a layout of the input areas within the soft input 130, modifying the size of the input areas, modifying the manner in which the input areas are displayed in the soft input 130 (e.g., brightness, coloring, etc.), and so on.

In some embodiments, an input model 142 (stored on the datastore 112) may be used to determine the probability that a particular input area of the soft 130 input will be selected given the current operating context (e.g., current user input, the application associated with the soft input 130, and so on.). The soft input manager 140 may determine whether to modify the soft input 130 (e.g., whether to generate a dynamic soft input) based upon current context information. For example, if the user is just beginning a new sentence, or has only entered one or two characters, there may be insufficient contextual information to modify the soft input 130 in a meaningful way. Alternatively, if the user is in the middle of a sentence (or has entered several characters of a word), there may be enough context to modify the soft input 130 (e.g., generate a dynamic soft input 130), that reflects the probability skew within the soft input 130 (e.g., excludes input areas that are highly unlikely to be selected, and highlights input areas that the user is likely to select next).

In some embodiments, the determination of whether to generate a dynamic soft input may comprise comparing the current context to one or more predefined threshold conditions (e.g., whether the user is in the middle of a word or sentence, or the like). Alternatively, or in addition, the determination may comprise comparing the conditional probability of each soft input 130 input area (e.g., key) to a probability threshold. Input areas falling below the threshold may be candidates for removal and, if a sufficient number of input areas can be excluded (or a subset are highly probable), the soft input manager 140 may generate a dynamic soft input 130. Otherwise, the soft input manager 140 may configure the soft input 130 to present a “default” or “full” soft input 130 (e.g., a full QWERTY keyboard).

When generating a dynamic soft input 130, the soft input manager 140 may use the relative probabilities of the input areas (e.g., keys) in the soft input 130, as determined by the input model 142 and other contextual information, to select which input areas to include the modified soft input 130, select the relative size of the input areas (e.g., size may be proportional to probability), select the layout for the soft input 130, and so on. The soft input manager 140 may communicate the modified input layout to the soft input 130 in markup, XML, or other format. One example of a method for generating a dynamic soft input 130 is described below in conjunction with FIGS. 3 and 5.

In some embodiments, the input model 142 may comprise a language model which, given a set of input characters, may indicate the probability that a particular character (or set of characters) will be entered next. For instance, if the user has entered a “q” character into the soft input 130, the input model 142 may indicate that the next input is likely to be a “u.” Other types of input models 142 could be used under the teachings of disclosure including, but not limited to: input models 142 for various languages (e.g., English, Spanish, German, etc.), domain-specific models (e.g., medical, legal, etc.), non-linguistic models (e.g., hierarchical menu, point-of-sale operations, etc.), and so on. For example, in a point-of-sale input model 142, the selection of a “discount” input, may indicate that the next inputs are likely to be selected from a pre-determined set of numeric values (e.g., within a predefined range from 10-30%).

FIG. 2 is a data flow diagram for generating a dynamic soft input. In the FIG. 2 example, a soft input 130 may receive input from a user (not shown) interacting with an application 122 operating within a graphical environment 120 (e.g., operating system, etc.). The soft input manager 140 may be configured to manage the soft input 130 based upon a current context 144. The context 144 may comprise inputs that the user has entered into the soft input 130, the nature of the application 122 (e.g., the application domain), and so on. Accordingly, and as shown in FIG. 2, user inputs entered via the soft input 130 may be monitored (e.g., flow through) the soft input manager 140. Alternatively, the soft input 130 may operate independently of the soft input manager 140 (e.g., the soft input manager 140 may monitor user inputs and/or context information using the graphical environment 120 and/or application 122).

The soft input manager 140 may use the context 144 and the input model 142 to determine whether to modify the soft input 130 (e.g., generate a dynamic soft input) as described above. In some embodiments, the soft input manager 140 may communicate the modifications 146 to the soft input 130 and/or module that implements the soft input 130.

### Operation

FIG. 3 is a flow diagram of one embodiment of a method 300 for providing a dynamic soft input. In some embodiments, the method 300 may be embodied on one or more machine-readable instructions stored on a non-transitory machine-readable storage medium (e.g., disc, non-volatile memory, or the like). The instructions may be configured to cause a machine (e.g., computing device) to perform one or more steps of the method 300.

At step 310, the method 300 may start and be initialized, which may comprise loading one or more machine-readable instructions from a machine-readable storage medium, initializing and/or allocating processing resources, and the like.

At step 320, the method 300 may determine whether to modify a soft input. Step 320 may comprise the soft input receiving “focus,” which may comprise the soft input being invoked and/or selected by a user. Step 320 may further comprise accessing context information (if any) associated with the soft input. As discussed above, context information may include, but is not limited to: user inputs entered into the soft input, the application associated with the soft input, and so on.

The determination of step 320 may be based upon whether there is sufficient contextual information to modify the soft input (e.g., whether a sufficient number of inputs can be excluded from the soft input).

FIG. 4 shows one example of a method 400 for making the determination of step 320. At step 322, the current state of the soft input may be examined to determine whether the user is in a “dynamic context.” A dynamic context may refer to a context in which probabilities for the next input are sufficiently skewed to allow the soft input to be modified in a meaningful way. Accordingly, the determination of step 322 may comprise accessing an input model (e.g., input model 142) to determine the relative probabilities of next inputs given the current user context. For example, a dynamic context may exist where the user is in the middle of typing a word (has typed one to three characters) and/or is in the middle of a sentence. A non-dynamic context exists where the user is beginning a new word or sentence. If at step 322 it is determined that the user is in a non-dynamic context, the flow may result in no-modification (e.g., the flow may continue to step 340 of FIG. 3); otherwise, the flow may continue to step 324.

At step 324, the length of the user input may be compared to a threshold (typically one to three characters per experience and/or testing). If the user input passes the threshold (is as long or longer than the threshold), step 324 may determine that the soft input may be modified (e.g., the flow may continue to step 330 of FIG. 3); otherwise, step 324 may determine that the soft input is not to be modified (e.g., the flow may continue to step 340 of FIG. 3).

At step 330, the method 300 may generate a modified soft input. As discussed above, generating a modified soft input may comprise removing one or more input areas, resizing input areas, and/or changing the layout of the soft input. The input areas may be modified to “highlight” input areas that are more likely to be selected by the user. The probability that a particular input area (e.g., key on a soft keyboard) is to be selected next may be determined by applying the current context (e.g., user input, application, etc).) to an input model (e.g., language model). Input areas having a higher probability of being selected next may be displayed more prominently in the modified soft input (e.g., larger, in a more prominent position, and/or using a more vibrant color).

FIG. 5 depicts one embodiment of a method 500 for generating a dynamic soft input at step 330. At step 531, the method 500 may calculate conditional probabilities for the input areas of the soft input. The conditional probabilities may comprise a plurality of tuples, each associating an input area (e.g. key) with a respective conditional probability. The conditional probability of an input area may reflect the probability that the input area will be selected as the “next” entry in the soft input. For example, if the context information indicates that the user has entered a “q,” the input area associated with “u” may be assigned a relatively high conditional probability.

As discussed above, the conditional probabilities may be calculated using the context information and an input model. In some embodiments (e.g., where the soft input comprises a keyboard), the input model may be a language model. In other embodiments, other input models may be used (e.g., point-of-sale model, etc.). Step 531 may comprise selecting an input model from a plurality of different, domain-specific input models. For example, the method 500 may have access to a medical input model, a legal input model, and so on. The selection of an input model at step 531 may be based contextual information, such as the application currently in use, user profile information, and so on.

At step 533, the tuples calculated at step 531 may be compared to a probability threshold. Tuples that satisfy the probability threshold may be selected for potential inclusion in the dynamic soft input. In some embodiments, the threshold may be adaptive and/or may be set according to the skew in the conditional probabilities (e.g., standard deviation). For example, the probability thresholds of step 533 may comprise a minimum conditional probability value and may be configured to limit the selected tuples to the top N conditional probabilities.

At step 535, the size, shape, position, and/or formatting of the input areas may be determined. Input areas having higher conditional probabilities may be displayed more prominently within the dynamic user input. Accordingly, the size, shape, position, and/or formatting of an input area may be tied to its conditional probability.

In some embodiments, the size, shape, and/or position of the input areas may be determined using a squarified TreeMap algorithm as described in “Tree Visualization with Tree-Maps: 2-d Space-Filling Approach” by B. Schneiderman, published in ACM Transactions on Graphics, 1992, which is hereby incorporated by reference. The algorithm may be modified to translate tuple probabilities into display area values (e.g., if the character T is 85% likely, then the input area for ‘i’ may be initially assigned 85% of the available keyboard display area). These raw values may be adjusted to give a more pleasing and effective layout to the keyboard. For example, each input area may be assigned a minimum size. Other adjustments may be made when the difference in probabilities is very high and/or there are very few characters to be displayed (such as for ‘u’ character following ‘Q’). In this case, for example, the adjusted area for the larger keys may be less than their raw values to allow the other keys to be shown larger.

In some embodiments, the tuples may be ordered by descending weighted probabilities so that the tuples with the highest conditional probabilities are placed in the upper left corner of the dynamic user input. Alternatively, if the user profile indicates that the user is left handed and/or prefers prominent inputs to be placed in a different area, the ordering and/or layout preferences may be modified.

At step 537, a layout for the dynamic input may be generated, which may comprise generating formatting data (e.g., XML document) describing the dynamic soft input generated at steps 531-535.

Step 537 may further comprise adding input areas that are specific to the dynamic soft input. For example, the dynamic soft input may comprise an input area configured to cause the “default” or “full” soft input to be displayed. Alternatively, or in addition, the dynamic soft input may comprise a feedback input, which may be used to “train” the input model.

In some embodiments, step 537 may further comprise storing the dynamic soft input in a datastore (e.g., datastore 112). The stored dynamic soft input may be retrieved on subsequent use (e.g., when the same, or similar, context is received at the method 500).

Referring back to FIG. 3, at step 335, the method 300 may determine whether the dynamic soft input (generated per method 500 above) is to be presented to the user. The determination of step 335 may be based on the conditional probabilities of the tuples used to generate the dynamic soft input. For example, if the sum of the conditional probabilities is not greater than a preset threshold (e.g., about 85%), then the dynamic keyboard may not be presented, and the flow may continue at step 340. If the sum of conditional probabilities exceeds the threshold, the dynamic soft input may be presented to the user, and the flow may continue to step 350.

At step 340, a non-dynamic (e.g., default) soft input may be retrieved. The non-dynamic soft input may comprise a “full” input (e.g., full QWERTY keyboard). Like the dynamic soft input described above, the non-dynamic soft input may be defined by an XML file (or other markup and/or formatting code).

At step 350, the soft input (dynamic or non-dynamic) may be presented to the user in the soft input, which, as discussed above, may comprise a display, touch screen, projector, or any other HMI component(s) known in the art.

At step 360, a next user input may be received via the soft input. At step 370, the user input may be handled by the application associated with the soft input (via an operating system and/or graphical environment), and the flow may continue at step 320 where a next dynamic soft input may be generated.

FIG. 6 depicts one embodiment of mobile device comprising a soft input. The soft input 601 depicted in FIG. 6 may be a “non-dynamic” soft input comprising a full QWERTY keyboard (as well as domain specific inputs, such as a search button, and the like). As described above, a non-dynamic soft input 601 may be provided per a user request, when there is insufficient context to generate a meaningful dynamic soft input, or the like.

FIG. 7 depicts one embodiment of a mobile device configured to display a dynamic soft input. In the FIG. 7 example, the user context information includes the string “The silly brown q,” as well as the application (e.g., messaging application). As described above, this context information may be used to generate a dynamic soft input. For example, the application context (messaging application) may be used to select a “natural” “casual” language input model that includes “textisms,” such as LOL, ROTFL, and so on. The selected input model (along with the input text) may be used to assign a relative probability to each potential input area in the soft input (e.g., a conditional probability may be assigned to each key a-z, number 0-9, punctuation mark, and so on). A soft input manager implemented on the device 700 may generate a dynamic soft input 702 as described above. FIG. 7 shows an exemplary dynamic soft input 702 in which the characters ‘u,’ ‘w,’ ‘a,’ have the highest conditional probabilities, followed by ‘e,’ ‘o,’ ‘f’, and ‘i.’ The dynamic soft input 702 may include an additional input area 706, which may be used to revert to the “default” or “full” soft input of FIG. 6.

As described above, the dynamic user input may be continuously updated as additional user inputs are received. FIG. 8 shows a device 800 comprising an exemplary dynamic soft input 803 after the user enters the ‘u’ character. As illustrated in FIG. 8, the dynamic soft input 803 is different than the dynamic soft input 702 of FIG. 7 since the conditional probabilities of the input areas have changed and, as such, a different set of input areas are displayed in the dynamic soft input 803.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention.

### Advantages

From the description above, a number of advantages of some embodiments of my dynamic soft keyboard become evident:

(a) The displayed keys are significantly larger than the normal soft keyboard keys. This larger size, typically three or four times as large on average, makes identifying the keys faster and makes striking them easier. These two improvements result in greater entry speed and accuracy.

(b) The keys are organized within the display layout so that those which are more likely to be struck next are located in one area of the display while those that are least likely to be selected next are located elsewhere. In a typical embodiment for right-handed users the most likely keys will be found on the upper left corner of the display, while the least likely keys will be found in the lower right corner. Since there is no fixed layout of the keys, arranging them in this fashion decreases the time needed for the user to select the next desired key, improving entry speed.

(c) The keys displayed are sized relative to their probability of being the next key selected. In a typical embodiment using the English language, after striking the key ‘Q’ as the first letter of a word, the ‘u’ key will be presented in the layout larger than all of the other displayed keys, for example. This improvement results in greater entry speed.

(d) The number of keys displayed is significantly reduced when compared to a traditional keyboard such as a QWERTY keyboard. The reduced set can be scanned more quickly by the user, increasing overall speed of operation.

(e) Unlike other methods of text entry such as the gesturing method described by Zhai in (U.S. Pat. No. 7,251,367) my method allows the user to spell words incrementally letter by letter rather than having to plan the entire word beforehand. This is easier for the user and reduces errors.

(f) Unlike other methods of text entry such as the popular “text on nine keys” (e.g. T9), my method does not require disambiguation of the text. This reduces the possibility of the user inadvertently entering the wrong word.

(g) The incremental presentation of the most likely next characters also serves a pedagogic function whereby the user becomes a more proficient speller with prolonged use of the invention.

(h) My method easily support languages with large character sets such as Chinese, where simultaneously displaying all or most of the possible characters in the language would either be impractical or confusing for the user or take up too much of the available display area.

### CONCLUSION, RAMIFICATIONS AND SCOPE

Accordingly the reader will see that the dynamic soft layouts of the various embodiments can display a reduced set of input areas that are larger and more likely to be selected increasing both speed and accuracy of text entry.

While the above description contains many specificities, these should not be construed as limitations on the scope of any embodiment, but as exemplifications of various embodiments thereof. Many other ramifications and variations are possible within the teachings of the various embodiments. For example, the soft input can be implemented in a standup kiosk of the kind that might be used in an airport or a bank automated teller machine. In such an implementation the soft input would display input areas corresponding to appropriate user choices.

Thus the scope should be determined by the appended claims and their legal equivalents, and not by the examples given.

I claim:

1. In a computer system having a graphical user interface, a method of enhancing a soft input or soft keyboard, comprising the steps of:
(a) providing a soft input manager;
(b) displaying an initial representation of a soft input, having fixed keys of traditional size and location;
(c) receiving input information from the user;
(d) obtaining a set of tuplets of predicted probabilities and keys from a language model based on input from the user;
(e) determining a reduced set of keys from the most likely of said tuplets;
(f) determining the sizes for each key in said reduced set of keys;
(g) determining the shapes for each key in said reduced set of keys;
(h) determining the locations of each key in said reduced set of keys;
(i) displaying a second representation of a soft input with said reduced set of keys, each of said keys having said determined size, shape and location whereby said soft input will display said set of likely next keys at said locations on the soft input and with said sizes and shapes, and a user can select the next key from a smaller group of possible keys with the most likely keys being presented larger and grouped together on the display.

2. The method of claim 1, wherein the soft input manager selects a reduced set of keys from said set of likely next keys based on a predetermined threshold expressed as a minimum probability value.

3. The method of claim 1, wherein the soft input manager selects a reduced set of keys from said set of likely next keys based on a predetermined threshold expressed as a a maximum number of keys to display.

4. The method of claim 1, wherein said user context is based on the current position within the sentence of the word being entered.

5. The method of claim 1, wherein said user context is based on the number of characters entered so far within the current word.

6. The method of claim 1, wherein said input model is a language model built from a corpus obtained via current popular social media tools such as Facebook or Twitter.

7. The method of claim 1, wherein said second representation displays said reduced set of keys with the most likely keys being placed optionally based on user choice in the upper left or upper right of said soft input when said soft input is oriented vertically.

8. The method of claim 1, wherein said second representation displays said reduced set of keys with the most likely keys being placed in the upper right and upper left of said soft input when said soft input is oriented horizontally.

9. The method of claim 1, wherein the soft input includes at least one key which will cause the soft input to display said initial representation rather than said second representation.

10. The method of claim 1, wherein said user context is based on the current application being utilized by the user.

11. A text-entry device for generating a soft input or soft keyboard comprising:
(a) a processor;
(b) a memory in communication with the processor;
(c) a touch screen in communication with said processor;
(d) a soft input manager stored on the memory;
wherein the soft input manager;
displays an initial representation of a soft input having a plurality of visible keys and respective footprints of traditional size and location;
generates a set of tuplets of predicted probabilities and keys from a language model after receiving user input from the soft input;
determines a reduced set of the most likely keys from said set of tuplets;
displays a second respresentation of the soft input comprising each of said reduced set of keys, with each key's size, shape, and location being based on its likelihood;
whereby said soft input will display said set of likely next keys at said locations on the soft input and with said sizes and shapes, and a user can select the next key from a smaller group of possible keys with the most likely keys being presented larger and grouped together on the display.
